(19) United States
(12) Patent Application Publication
(10) Pub. No.: US 2014/0268244 A1
(43) Pub. Date: Sep. 18, 2014

(54) REDACTING AND PROCESSING A DOCUMENT

(71) Applicant: HEWLETT-PACKARD DEVELOPMENT COMPANY, LP., Houston, TX (US)

(72) Inventors: William A. Sheridan, Gilbert, AZ (US); Ram Prasad Atmakur, Bangalore (IN)

(73) Assignee: HEWLETT-PACKARD DEVELOPMENT COMPANY, L.P., Houston, TX (US)

(21) Appl. No.: 13/832,927

(22) Filed: Mar. 15, 2013

(51) Int. Cl. H04N 1/00

(52) U.S. Cl. CPC H04N 1/00864
USPC 358/403

(57) ABSTRACT

An electronic document is produced from scanning a physical document that is to be subjected to redaction. The electronic document is sent to at least one device associated with at least one reviewer. Data relating to redaction input by the at least one reviewer is received. One of plural different options for processing the physical document is selected based on which of plural completion statuses has been marked for the electronic document.

### BACKGROUND

An enterprise may be in possession of documents that contain sensitive information. In some cases, the documents maintained by an enterprise may be requested by an outside party. For example, if the enterprise is a government agency, an outside party may request documents under a law or regulation (e.g. Freedom of Information Act in the United States) that specifies that documents (even if they contain sensitive information) be released after some amount of time has elapsed. In other examples, documents may be the subject of requests made during litigation or in other contexts.

### BRIEF DESCRIPTION OF THE DRAWINGS

Some embodiments are described with respect to the following figures:

FIG. 1 is a block diagram of an example system according to some implementations;

FIG. 2 is a flow diagram of a document handling process according to some implementations;

FIG. 3 is a block diagram of an example system according to alternative implementations; and

FIG. 4 is a block diagram of a computing system according to some implementations.

### DETAILED DESCRIPTION

When archiving documents containing sensitive information, an enterprise (e.g. a government agency, a business concern, an educational organization, an individual, and so forth) may wish to hide the sensitive information contained in the documents in anticipation of the possibility that these documents may be released at the request of parties at a later date. Examples of sensitive information that may be contained in a document can include confidential information, classified information, personal information, and so forth. A way to hide sensitive information in a document is to redact the information, where redacting can refer to masking the information, blurring the information, altering the information such that it becomes illegible, or any other modification of the document in which portion(s) of the document containing sensitive information is (are) modified to prevent their disclosure.

In preparation for the release of documents containing sensitive information, an enterprise may in some cases manually redact portions of the documents containing the sensitive information. Manual redaction can include applying masking tape or other items to the documents, followed by the photocopying the masked documents. In other cases, the redaction applied to a document can be performed electronically, such as by a standalone multifunction printer, or by a photocopier.

Various redaction techniques may not be suited for the efficient redaction of relatively large volumes of documents. In addition, there is some risk that the original physical documents may be lost, misplaced, or stolen at various points during handling of the physical documents associated with the redaction process. For example, physical documents may be handled in public areas, and may be left on desks or photocopying machines. The lost, misplaced, or stolen physical documents may be inadvertently or intentionally disclosed to outside parties, which can result in disclosure of sensitive information contained in such physical documents.

In accordance with some implementations, a cloud-based system is provided to allow for more efficient redaction of documents prior to release of such documents to requesting parties or transfer of such documents to alternate low-security storage. A cloud-based system has one or multiple entities that are able to communicate over a network. The cloud-based system allows for different personnel of an enterprise to handle different aspects of the document handling and processing, including document redaction, document filing, document disposal, and so forth. In addition, the cloud-based system allows for electronic access of the redacted documents over a network.

When dealing with a large number of documents and a wide variety of documents, different personnel may have to be used to apply specialized knowledge or experience for ascertaining which portions of documents are sensitive and thus are to be redacted. Different types of documents may be sent to different personnel who possess knowledge regarding the context of the respective types of documents, such that more effective redaction can be performed. By using the cloud-based system according to some implementations, electronic documents that represent scanned versions of physical documents can be routed to the appropriate personnel in a more efficient manner.

FIG. 1 is a block diagram of an example system according to some implementations. A physical document 102 is provided to a redaction control system 104 according to some implementations. The redaction control system 104 can include a multifunction document device and a workflow server (which can be separate machines or which can be integrated into one machine) to perform various specified tasks associated with the redaction control system 104. The multifunction document device can scan a document and print a document. In some examples, the multifunction document device can also include a shredder to shred a physical document. The physical document 102 is scanned by the multifunction document device, to produce a raw electronic document 106.

Although reference is made to a redaction control system having one multifunction document device and one workflow server, it is noted that in other examples, a redaction control system can include multiple multifunction document devices and/or multiple workflow servers.

In some examples, physical documents can be brought to a secure workspace where the multifunction document device is located. If there are a large number of physical documents, the physical documents can be partitioned into groups that are assigned to respective different personnel to scan. Also, an identifier label can be printed on or affixed to each physical document. The identifier label can include identification information, such as a barcode or other type of identifier, to allow for identification of the respective document (both the physical document and the respective electronic document).

After scanning, the physical documents can be placed in a specified location, such as in a tickler file or other physical location, for subsequent follow-up. Note that the physical documents can be kept at the secure workspace, to reduce the chances of loss, misplacement, and theft of the physical documents.

The raw electronic document 106 produced by the scanner can be sent by the workflow server of the redaction control system 104 to a computing device 108 that is associated with a reviewer. The reviewer can be any personnel of an enterprise that is designated to perform a review of a particular electronic document or set of documents to identify portion(s) of the electronic document to redact. Although just one reviewer is depicted in FIG. 1, it is noted that there can be multiple reviewers associated with respective computing devices 108 in other examples. Different reviewers can be designated to review different categories or types of documents, for purposes of identifying information to redact. Different reviewers can have different knowledge regarding different categories or types of documents.

The reviewer can use the computing device 108 to perform redaction of the raw electronic document 106. For example, the computing device 108 can include a redaction tool in the form of machine-readable instructions that are executable in the computing device 108. Using a user input device, the reviewer can select portion(s) of the raw electronic document 106 to be redacted. In some examples, redacted portions of the electronic document can be ranked according to sensitivity or predefined access levels. The locations of the redacted regions can also be recorded.

After redaction has been performed, the reviewer causes the computing device 108 to send a processed electronic document 110 to the redaction control system 104. The processed electronic document 110 can be a version of the raw electronic document 106 with portion(s) redacted. For example, the processed electronic document 110 can include a document image in which redaction graphical elements (such as black rectangles or other masking or obscuring graphical elements) have been inserted into the document image. In other examples, the processed electronic document 110 can include the raw electronic document 106 (unmodified) along with associated metadata that indicates portion(s) of the raw electronic document 106 that has (have) been redacted. The metadata can identify location(s) of the redacted portion(s).

The reviewer can mark one of multiple different completion statuses for the processed electronic document 110. For example, one completion status that can be marked is a Complete or Destroy/Complete completion status (which indicates that processing for the respective physical document has completed and the respective physical document can be destroyed). Another completion status can be a Store with Masking status (which indicates that a redacted physical document should be physically kept, while the original physical document is destroyed). Another possible completion status is a Store status, which indicates that the physical document should be kept and not destroyed. Yet another completion status can be an Incomplete status (which indicates that processing for a respective physical document has not yet completed).

In other examples, the completion status of a document can be marked by personnel different from the reviewer. For example, the completion status can be marked by the document owner, which is the personnel responsible for determining how the physical document should be disposed. Note that in some cases, the document owner can be assigned the role of a reviewer to review a document for redacting portions of the document.

Depending on which completion status was marked, the redaction control system 104 can cause selection of one of different options for performing physical document processing 112. The redaction control system 104 causes a physical document 114 to be routed to an entity for performing the physical document processing 112. The physical document 114 can be the same as the input physical document 102, or alternatively, the physical document 114 can be a modified form of the input physical document 102. For example, the physical document 114 can be the physical document 102 with an identifier label applied.

The redaction control system 104 causing the physical document 114 to be routed to an entity for performing the physical document processing 112 can include the following, as an example. The redaction control system 104 can send a message (e.g. an email, text message, etc.) to personnel to retrieve a particular physical document 114 from the tickler file or other physical location, and to load the particular physical document 114 into the entity.

The entity to which the physical document 114 is routed can be a destruction machine, such as a shredder or any other machine that can be used for destroying a physical document. One such entity can be the multifunction document device, which includes a shredder. In other examples, other types of entities can be used.

Prior to applying the physical document processing 112, the identifier label on the physical document 114 can be compared to an identifier label of a respective processed electronic document.

One option for the physical document processing 112 is destruction of the physical document 114, if the respective processed electronic document 110 is marked as Complete or Destroy/Complete by the reviewer.

On the other hand, if the processed electronic document 110 is marked with the Store with Masking status, then a different option for the physical document processing 112 is used. With this option, the physical document 114 is also sent to a destruction machine for destruction. However, with this option, the physical document processing 112 also causes a redacted physical document to be printed, based on the processed electronic document 110. This redacted physical document is then output to an output location (e.g. an output tray of a printer) for filing in a physical storage location. The completion status of the respective processed electronic document 110 can then be changed to indicate a Complete or Destroy/Complete status.

As another example, the processed electronic document 110 is marked with the Store status, which leads to another option being used for the physical document processing 112. With this option, the physical document 114 is not destroyed, but rather is caused to be routed to a physical storage location for safekeeping.

If the reviewer had not indicated a Complete or Destroy/Complete status, a Store with Masking status, or a Store status, then the processed electronic document 110 is associated with an Incomplete status. In this case, another option is chosen for the physical document processing 112. With this latter option, the redaction control system 104 can route the physical document 114 to a different entity, such as a separate output tray or other location that contains physical documents that are to be further processed.

When the processed electronic document 110 is marked with the Complete or Destroy/Complete status, or Store with Masking status, or Store status, the processed electronic document 110 can be sent by the redaction control system 104 to a data server system 116 for storage at the data server system 116. In addition to the processed electronic document 110, metadata associated with the processed electronic document 110 can also be sent by the redaction control system 104 to the data server system 116 for storage. The metadata can include information identifying portion(s) of the processed electronic document 110 that has (or have) been masked, index information to allow for an index to be used to access the processed electronic document 110, access level(s) associated with the redacted information, content of the processed electronic document 110, and so forth. Where there are multiple redacted portions, the metadata can also include information that ranks the redacted portions according to sensitivity or access levels.

The content of the processed electronic document 110 can include the actual content (both redacted and non-redacted) of the processed electronic document 110, including text data, images, charts, graphical elements, and so forth. The redacted content can be protected by security information to disallow any access by requesting parties that are not authorized to access the redacted content. Only those requesting parties that have the requisite access level (indicated in the access level information of the metadata) would be able to access the redacted content of the respective processed electronic document 110.

Processed electronic documents stored in the data server system 116 can be accessed by requesting parties over the cloud (which includes a network). In response to a request, a redacted document image can be sent to the requesting party, where the redacted document image is based on the respective processed electronic document and associated metadata stored in the data server system 116.

FIG. 2 is a flow diagram of a redaction control process that can be performed by the redaction control system 104 according to some implementations. The redaction control system 104 receives (at 202) an electronic document that is a scanned version of a physical document that is to be subjected to redaction. The electronic document can be based on scanning a physical document (e.g. 102 in FIG. 1) by a multifunction document device in the redaction control system 104, for example.

The redaction control system 104 can send (at 204) the electronic document to at least one computing device (e.g. 108 in FIG. 1) that is associated with at least one reviewer. The redaction control system 104 then receives (at 206) data relating to input by the at least one reviewer of the electronic document, where the received data identifies at least one redacted portion of the electronic document. The input by the reviewer can include input using a user input device that identifies portion(s) of the electronic document to be redacted. The data received (at 206) can include metadata that identifies the location(s) of the redacted portion(s) in the electronic document. Alternatively, the data received can be a document image of the electronic document, where the document image includes redaction graphical elements that redact the identified portion(s).

The redaction control system 104 then causes storage (at 208) of the received data and content of the electronic document, such as in the data server system 116 of FIG. 1. In addition, the redaction control system 104 selects (at 210) one of multiple different options for physical document processing (e.g. 112 in FIG. 1), based on which of plural completion statuses has been marked for the electronic document.

In other examples, a reviewer to which a document is sent may decide not to redact any portion of the document. In such examples, the process of FIG. 2 can remain substantially the same, except that the system does not produce a graphical element to mask any portion of the document. For example, the document may still the marked with metadata (e.g. security information).

FIG. 3 is a schematic diagram pertaining to performance of document redaction, processing, and retrieval, according to alternative implementations. As shown in FIG. 3, the redaction control system 104 includes a workflow server 306 (e.g. a computer server) and a multifunction document device 308. FIG. 3 also shows various different personnel, including document handlers 302, document reviewers 305, and document owners 305.

In some examples, the document handlers 302 can collect and classify groups of physical documents that potentially contain sensitive information. The classification of physical documents into groups can be based on one or multiple characteristics, including a source of a document, an owner of a document, an author of a document, a security level of a document, and so forth. Information pertaining to the groups of physical documents can be entered by the document handlers 302 into one or multiple computing devices 304 associated with the document handlers 302.

An application that is executable in each computing device 304 can be downloaded from a cloud system 350, which can include various different applications 352 for use in different computing devices. Different applications 352 can perform different tasks relating to document redaction, document processing, and document retrieval, in accordance with some implementations.

The group information can be sent by the computing device(s) 304 to the workflow server 306, where the group information can be stored. The group information can be used by the workflow server 306 to identify different groups of documents.

Although shown as two separate systems, the multifunction document device 308 and the workflow server 306 can be integrated as a single machine in further examples. Also, there can be more than one multifunction document device 308 and/or more than one workflow server 306.

The multifunction document device 308 can be provided on a desktop of a document handler 302, or alternatively, the multifunction document device 308 can be shared by multiple document handlers 302.

To use the multifunction document device 308, a document handler 302 may have to first log onto the multifunction document device 308, using either a respective computing device 304 or using a touch-sensitive display panel 310 of the multifunction document device 308.

Once a document handler 302 has successfully logged into the multifunction device 308, the document handler 302 can enter information identifying the document group of the physical document 102 that is to be processed.

A scan of the physical document 102 by the multifunction document device 308 produces an electronic document that can be provided to the workflow server 306 for storage. In addition, the multifunction document device 308 can produce an identifier label that can be printed onto the physical document 102, or alternatively, can be printed onto a label that can be physically affixed to the physical document 102. The identifier label can uniquely identify the physical document. This identification information can also be used to identify the corresponding electronic document produced by scanning the physical document 102.

The identification information in the identifier label can also be encoded with additional information, such as a follow-up date information that specifies a date by which further processing of the document is to be completed.

In other examples, the identification information can include a uniform resource locator (URL) that can be provided as plain text or in the machine-readable form. Alternatively, the identification information can be hashed text that is printed onto the physical document. Hashed text refers to text that has been encoded.

The physical document 114 (which is the physical document 102 after the identifier label has been added to the physical document 102) can be routed to a specified location, such as a specified output tray of the multifunction document device. A document handler 302 can retrieve (at 312) the physical document 114 from the specified location, and can place the physical document 114 in a tickler file or other location for follow-up. Physical documents stored in the tickler file can be sorted by follow-up dates associated with the physical documents. A physical document can be retained in the tickler file until the respective follow-up date is reached, at which point a document handler 302 retrieves the physical document from the tickler file for further processing.

Based on owner information associated with the physical document, the workflow server 306 can route the respective electronic document to a computing device 314 associated with a document owner 305 or document owner group. In some cases, the document owner or document owner group can be a freedom of information officer or equivalent personnel. The document owner 305 can determine if the physical document should be stored, stored with masking of sensitive data, or destroyed. In some examples, the completion status of the physical document can be marked accordingly by the owner (similar to the process described further above). In alternative examples, as discussed above, the marking of a completion status can be performed by a reviewer (303 in FIG. 3).

As further depicted in FIG. 3, the electronic document produced based on scanning the physical document 102 can be routed (at 316) by the workflow server 306 to the computing device 108 of a reviewer or a group of reviewers 303.

The reviewer or group of reviewers 303 can use the computing device 108 (or multiple computing devices 108) to perform redaction of the electronic document. An application can be executed in each computing device 108 to perform the redaction. Such redaction application can be downloaded from the cloud system 350.

Instead of using computing device(s) 108 to perform redaction, a reviewer 303 can instead use the touch-sensitive display panel 310 of the multifunction document device 308 to perform the redaction.

The content of the electronic document (including text and/or other types of content, such as graphical elements) are marked for masking based on the user input. In addition, non-redacted content information of the electronic document, including text and graphical elements, can be extracted and stored. Location information can be associated with each text and/or graphical element that is extracted, where the location information can identify the location of the respective element in the electronic document. In addition, further information such as the identification of the reviewer and the date of review can also be associated with the electronic document. In some examples, text regions of the electronic document can be processed by an optical character recognition (OCR) tool, to allow for recognition of text. Portions of the electronic document that are marked for redaction can be saved with a respective security information (e.g. access levels) for protection of the security information such that the redacted content is not presented to unauthorized requesting parties.

The reviewer can mark the completion status (one of the completion statuses listed above) of the processed electronic document, using the computing device 108 or the touch-sensitive display panel 310. The marked completion status can be provided to the workflow server 306 to associate with the electronic document.

In some examples, a reviewer or document owner can specify that a final approval procedure be associated with a processed electronic document that has been redacted by a reviewer (or multiple reviewers). If final approval is specified, the workflow server 306 can route a task to a document owner to enable the document owner to access the processed electronic document (containing redacted content), along with metadata of the processed electronic document 110. The document owner can then mark the completion status in this scenario.

If the electronic document is marked with the Complete or Destroy/Complete status or Store with Masking status, then the electronic document can be sent by the workflow server 306 to the data server system 116 for storage.

Document handlers 302 can retrieve processed physical documents from the ticker file as the physical documents become due. These documents can be placed in a feeder tray to the multifunction document device 308. The multifunction document device 308 can identify each physical document based on the identifier label on the document. Physical document processing 112 can then be performed based on the completion status associated with each identified physical document.

For example, if the document is marked with the Complete or Destroy/Complete status, or with the Store with Masking status, then the physical document processing 112 would involve routing the physical document (315) to the multifunction document device 308 for shredding (in the case of Complete or Destroy/Complete status), or for shredding, printing of a redacted physical document, and filing in a physical storage location (in the case of Store with Marking status). The metadata associated with the processed physical document can be updated by the workflow server 306 to indicate the physical processing that has been applied.

If the document is marked with an Incomplete status, then the physical document can be placed (at 317) by a document handler 302 in a tickler file for further processing. The workflow server 306 can send a reminder to a reviewer 303 or document owner 305 indicating that there are pending activities with respect to the physical document that have to be performed.

As further shown in FIG. 3, a requesting party can use a computing device 322 to access the information stored in the data server system 116 over a network 320. In response to a request for a document stored in the data server system 116, a document image containing redaction graphical elements can be provided to the requesting party, which effectively provides the requesting party a redacted copy of the document.

In addition to being able to access a redacted electronic document, a requesting party is also able to request access to redacted information, if the requesting party has the requisite access level. The identifier label on the electronic document can be used to retrieve the redacted information. The access level of the requesting party can be compared to the access level stored with redacted content, and the requesting party is allowed access to the redacted content if it is determined that the requesting party has a high enough access level. In some examples, a form can be provided with the redacted document copy to allow the requesting party to request access of redacted information. In other examples, other instructions can be provided to the requesting party.

An application for requesting and accessing documents in the data server system 116 can also be downloaded from the cloud system 350. Utilizing the application executed in the computing device 322, the requesting party can be presented with the redacted document copy, or a new document in which the redacted content is visible (assuming the requesting party has the requisite security level to access the redacted content). Depending on the sensitivity of a document, a requesting party may be restricted to only viewing the document on the computing entity 322. For less sensitive documents, printing of the documents may be allowed.

By using techniques or mechanisms according to some implementations, control of documents containing sensitive information may be maintained during handling and processing of physical documents, to reduce the likelihood that the physical documents may be lost, misplaced, or stolen. Also, the physical documents can be maintained (not destroyed), until the processing of the respective electronic documents has been marked as having an appropriate completion status. An identifier label on a physical document can be matched to an identifier label on an electronic document, to allow matching of the physical and electronic documents. This reduces the chances of error in matching documents. Also, by updating metadata associated with the documents, an audit trail can be created of the processing steps taken with respect to the documents.

FIG. 4 is a block diagram of an example computing system 400, which can represent the workflow server 306, any of the computing systems 304, 108, 314, and 322 in FIGS. 1 and 3, or the computing part of the multifunction document device 308. The computing system 400 includes document handling logic 402 according to some implementations, where the document handling logic 402 can be executable on any of the workflow serer 306, multifunction document device 308, or any of the computing devices depicted in FIGS. 1 and 3.

The document handling logic 402 can include machine-readable instructions executable on one or multiple processors 404. A processor can include a microprocessor, microcontroller, processor module or subsystem, programmable integrated circuit, programmable gate array, or another control or computing device.

The computing system 400 further includes a network interface 406 to communicate over a network, and a computer-readable or machine-readable storage media storage medium (or storage media) 408. Data and instructions can be stored in the storage medium (or storage media) 408. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving, by a system, an electronic document that is a scanned version of a physical document that is to be subjected to redaction;
sending, by the system, the electronic document to at least one device associated with at least one reviewer;
receiving, by the system, data relating to input by the at least one reviewer of the electronic document, the received data identifying at least one redacted portion of the electronic document;
causing storage, by the system, of the received data and content of the electronic document; and
selecting, by the system, one of plural different options for processing the physical document based on which of plural completion statuses has been marked for the electronic document.

2. The method of claim 1, further comprising:
receiving, by the system over a network, a request to access the electronic document; and
providing a document image in response to the request, wherein the document image is a redacted version of the electronic document.

3. The method of claim 1, wherein the selected option for processing the physical document comprises destroying the physical document.

4. The method of claim 1, wherein the selected option for processing the physical document comprises destroying the physical document and printing a redacted version of the physical document.

5. The method of claim 1, wherein the selected option for processing the physical document comprises outputting the physical document to a physical location for further handling.

6. The method of claim 1, further comprising:
receiving, by the system, a second electronic document that is a scanned version of a second physical document that is to be subjected to redaction;
sending, by the system, the second electronic document to a second device associated with a second reviewer;
receiving, by the system, data relating to input by the second reviewer of the second electronic document, the received data relating to the input by the second reviewer identifying at least one redacted portion of the second electronic document;
causing storage, by the system, of the received data relating to the input by the second reviewer and content of the second electronic document; and
selecting, by the system, one of plural different options for processing the second physical document based on which of plural completion statuses has been marked for the second electronic document.

7. The method of claim 1, further comprising:
associating an access level with the redacted portion, wherein the access level is used to determine whether a requesting party is able to access the redacted portion.

8. The method of claim 1, wherein the redacted at least one portion includes plural redacted portions of the electronic document, the method further comprising:
associating access levels with the respective plural redacted portions, the access levels being used to determine whether a requesting party is able to access the plural redacted portions.

9. The method of claim 1, further comprising:
causing storage of metadata with the electronic document, wherein the metadata includes information relating to actions applied to the physical document and electronic document.

10. A system comprising:
a document subsystem to scan a physical document to produce an electronic document, wherein the document subsystem is to further generate identification information to apply to the physical document, wherein the identification information is also associated with the electronic document; and
a workflow server to:
send the electronic document to at least one device associated with at least one reviewer;
receive a processed document that includes information redaction based on input of the at least one reviewer with respect to the electronic document;
cause storage of the processed document for subsequent retrieval; and
select one of plural different options for processing the physical document based on which of plural completion statuses has been marked for the electronic document.

11. The system of claim 10, wherein the workflow server is to further extract text and graphical elements of the electronic document, and to store the extracted text and graphical elements, wherein a redacted portion of the electronic document includes at least one of the text and graphical elements, and wherein the at least one of the text and graphical elements in the redacted portion is associated with security information.

12. The system of claim 10, wherein the security information is useable to determine whether a requesting party of the electronic document is allowed access of the redacted portion.

13. The system of claim 10, wherein causing storage of the processed document comprises causing storage of the processed document in a data server system that is accessible by a computing device over a network.

14. The system of claim 10, wherein the document subsystem is a multifunction document device that is to scan the physical document and to print a copy of the electronic document.

15. The system of claim 14, wherein the multifunction document device further includes a shredder to destroy the physical document according to a selected one of the options.

16. The system of claim 10, wherein the workflow server is to send the electronic document to one of plural reviewers according to a category of the electronic document.

17. The system of claim 10, wherein the document subsystem is to provide different paths for the physical document according to which of the different options is selected.

18. An article comprising at least one machine-readable storage medium storing instructions that upon execution cause a system to:
receive an electronic document that is produced from scanning a physical document that is to be subjected to redaction;
sending the electronic document to at least one device associated with at least one reviewer;
receive a processed document that includes the electronic document and metadata relating to redaction input by the at least one reviewer of the electronic document;
cause storage of the processed document for subsequent retrieval; and
select one of plural different options for processing the physical document based on which of plural completion statuses has been marked for the electronic document.

19. The article of claim 18, wherein the selected option for processing the physical document comprises destroying the physical document.

20. The article of claim 18, wherein the selected option for processing the physical document comprises destroying the physical document and printing a redacted version of the physical document.
